(19) United States
(12) Patent Application Publication
(10) Pub. No.: US 2012/0131013 A1
(43) Pub. Date: May 24, 2012

(54) TECHNIQUES FOR RANKING CONTENT BASED ON SOCIAL MEDIA METRICS

(75) Inventors: Daniel Hobbs, San Francisco, CA (US); Daniel Schmidt, San Francisco, CA (US); Doug Asherman, Oakland, CA (US)

(73) Assignee: CBS INTERACTIVE INC., San Francisco, CA (US)

(21) Appl. No.: 12/950,356

(22) Filed: Nov. 19, 2010

(51) Int. Cl. G06F 17/30

(52) U.S. Cl. 707/748; 707/E17.005; 707/E17.009

(57) ABSTRACT

Techniques to rank content based on social media metrics are described. In some embodiments, a method rank content based on social media metrics may include selecting a plurality of content contained on one or more web servers, requesting social media trending information for the plurality of content from one or more social media servers, calculating a social metric score for each of the plurality of content using the social media trending information and ranking the content based on the social metric score. Other embodiments are described and claimed.

### BACKGROUND

Social media comprises a diverse set of media for social interaction, using highly accessible and scalable publishing techniques. Social media may utilize web-based technologies to turn communication into interactive dialogues, often using user-generated content. In addition to social media, the content contained on websites is becoming increasingly dynamic, with some sites including content that is updated or changed on a frequent basis. Maintaining up to date lists of recent and trending content is one important aspect of maintaining a dynamic website. When a user visits a website, it is advantageous to provide tools that enable a user to select, sort or search for content in a variety of ways. It may be advantageous, for example, to sort content based on trends in the social media. As a result, it is desirable to enhance the dynamic ranking or sorting of content on a website. For example, it may be advantageous to create a tool that is operative to sort content based on trends in the social media using social media services. Consequently, there exists a substantial need for techniques to improve the ranking of content based on social media metrics. It is with respect to these and other considerations that the present improvements have been needed.

### BRIEF DESCRIPTION OF THE DRAWINGS

FIG. 1 illustrates an embodiment of a system.

FIG. 2A illustrates an embodiment of a user interface.

FIG. 2B illustrates an embodiment of a first logic flow.

FIG. 3 illustrates an embodiment of a second logic flow.

FIG. 4 illustrates an embodiment of a computing architecture.

FIG. 5 illustrates an embodiment of a communications architecture.

### DETAILED DESCRIPTION

Various embodiments are directed to techniques to rank content based on social media metrics. In some embodiments, for example, a computer-implemented method to rank content based on social media metrics may comprise selecting a plurality of content contained on one or more web servers, requesting social media trending information for the plurality of content from one or more social media servers, calculating a social metric score for each of the plurality of content using the social media trending information and ranking the content based on the social metric score. In some embodiments, a tool to efficiently rank content based on social media metrics may be described. The tool or method may provide a means to rank content on a website based on information obtained from social media services about the sharing of the content.

In some embodiments, the tool may reside on one or more servers and may be operative to allow users to access or organize content based on the ranking and sorting. In some embodiments, the content may include, but is not limited to, news stories, reviews, data files, image files, .dat files, .html files or any other suitable data or files. Other embodiments are described and claimed.

Ranking of content on a website is not a new concept. Tools exist to allow users to view content that is trending on a particular website. These tools, however, generally do not aggregate social media data from a plurality of sources to calculate a social media metric for ranking the content. These and other features are described in the following techniques, methods, articles and apparatus. As a result, the described embodiments can improve the dynamic ranking of content based on social media metrics.

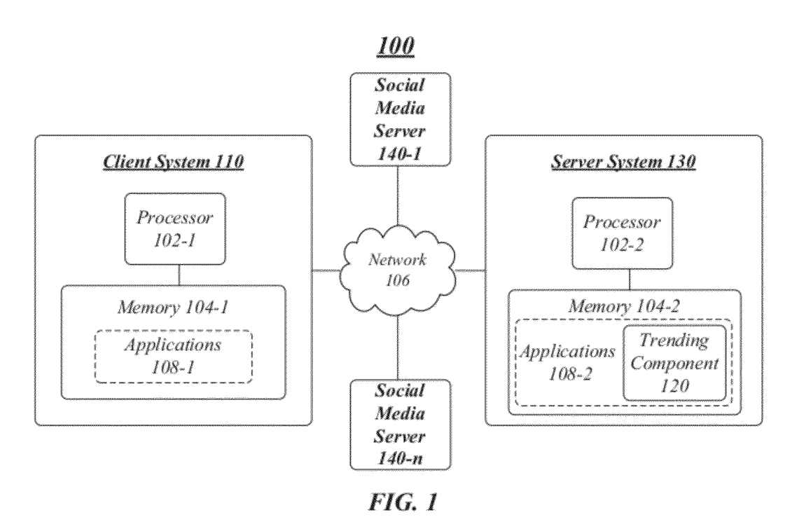

FIG. 1 illustrates a block diagram for a system 100 to rank content based on social media metrics. In one embodiment, for example, the system 100 may comprise a computer-implemented system 100 having multiple components 110, 130 and 140-1-n. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components 110, 130 and 140-1-n may be communicatively coupled via various types of communications media. The components 110, 130 and 140-1-n may coordinate operations between each other. The coordination may involve the uni-directional or bi-directional exchange of information. For instance, the components 110, 130 and 140-1-n may communicate information in the form of signals communicated over network 106. The information can be implemented as signals allocated to various signal lines or signals transmitted using any suitable signaling protocol. Other embodiments are described and claimed.

System 100 may comprise a distributed system in some embodiments. The distributed system 100 may distribute portions of the structure and/or operations for the system across multiple computing entities. Examples of distributed system 100 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, for example, the distributed system 100 may be implemented as a client-server system. A client 110 may be implemented as or comprise a user device, such as a personal computer, that may include one or more applications 108-1. A server system 130 may comprise a web server or other suitable device and may implement trending component 120. Social media servers 140-1-n may comprise third party servers arranged to provide social media services for one or more social media service providers or website. The client 110 and the servers systems 130 and 140-1-n may communicate with each over a network 106. In one embodiment, for example, the network 106 may comprise a wireless local area network (WLAN) or any other suitable computer network.

In various embodiments, the servers 130 and 140-1-n may comprise or employ one or more server computing devices and/or server programs that operate to perform various methodologies in accordance with the described embodiments. For example, when installed and/or deployed, a server program may support one or more server roles of the server computing device for providing certain services and features. Exemplary servers 130 and 140-1-n may include, for example, stand-alone and enterprise-class server computers operating a server OS such as a MICROSOFT® OS, a UNIX® OS, a LINUX® OS, or other suitable server-based OS. Exemplary server programs may include, for example, communications server programs such as Microsoft® Office Communications Server (OCS) for managing incoming and outgoing messages, messaging server programs such as Microsoft® Exchange Server for providing unified messaging (UM) for e-mail, voicemail, VoIP, instant messaging (IM), group 1M, enhanced presence, and audio-video conferencing, and/or other types of programs, applications, or services in accordance with the described embodiments.

In various embodiments, client system 110 and server system 130 may include, without limitation processors 102-1 and 102-2, memory 104-1 and 104-2 and applications 108-1 and 108-2. While not shown in FIG. 1, social media servers 140-1-n may include the same or similar components to server system 130. In some embodiments, server system 130 may additionally include trending component 120. Trending component 120 may comprise one of applications 108-2 in some embodiments. In various embodiments, a component such as trending component 120 may comprise hardware, software or any combination of hardware and software and still fall within the described embodiments. While trending component 120 is shown as part of server system 130 in FIG. 1, it should be understood that trending component 120 could be included anywhere in system 100 and still fall within the described embodiments. For example, trending component 120 could be implemented on client system 100 or in any of social media servers 140-1-n in some embodiments. Other embodiments are described and claimed.

Processors 108-1 and 108-2 may comprise or include any type of processing unit, such as, for example, CPU, multi-core processor, multi-processing unit, a reduced instruction set computer (RISC), a processor that has a pipeline, a complex instruction set computer (CISC), digital signal processor (DSP), and so forth. In some embodiments, processors 102-1 and 102-2 may comprise or include logical and/or virtual processor cores. Each logical processor core may include one or more virtual processor cores in some embodiments. For example, each processor 102-1 and 102-2 may comprise a multi-core processor having two virtual cores resulting in a total of eight available cores for multi-core processors 102-1 and 102-2. The embodiments are not limited in this respect and other embodiments are described and claimed.

In various embodiments, memory 104-1 and 104-2 may comprise any suitable type of memory unit, memory device, memory article, memory medium, storage device, storage article, storage medium and/or storage unit, for example, memory, removable or non-removable media, volatile or non-volatile memory or media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like.

Applications 108-1 and 108-2 may comprise any application, logic, module or set of computer instructions suitable for execution by client system 110 or server system 130 in some embodiments. For example, applications 108-1 and 108-2 may include, without limitation, an operating system (OS), e-mail application, web browsing application, word processing application, media application, and so forth. While a limited number and type of applications are described for purposes of clarity, it should be understood that any suitable application could be used and still fall within the described embodiments.

In various embodiments, trending component 120 may comprise one of applications 108-2. While trending component 120 is shown as an application 108-2 contained in memory 104-2 for purposes of illustration, it should be understood that trending component 120 could be located anywhere in system 100 and still fall within the described embodiments. For example, trending component 120 need not be contained within memory 104-2. Trending component 120 may provide or comprise a trending application or tool in some embodiments. For example, trending component 120, when executed by processor 102-2, may be operative to rank content based on social media metrics obtained from one or more of social media servers 140-1-n. Other embodiments are described and claimed.

In various embodiments, the trending component 120 may be programmed in accordance with various programming languages, application platforms and application frameworks, including JAVA made by Oracle Corporation, COLDFUSION made by Adobe Systems, .NET made by Microsoft® Corporation, WebORB for .NET, Hypertext Preprocessor (PHP), Ruby, Python, Perl, Lisp, Dylan, Pike, Cluster (CLU), Smalltalk, Eiffel, Ruby on Rails (RoR), C, C++, C#, and so forth. The logic 120 may also comprise part of a RIA, such as a front-end of a SOA for deployment on a web browser of a client computing device using various client side technologies, such as an Adobe Flash platform programmed in an object-oriented programming language such as ACTIONSCRIPT™ and ADOBE® FLEX, made by Adobe Systems Incorporated. It may be appreciated that these programming languages are provided by way of example and not limitation. Trending component 120 may be implemented using any suitable programming language.

Trending component 120 may be operative to sort or rank content based on social media metrics in some embodiments. For example, a user of client system 110 may access a website containing news stories, user reviews or other suitable content. A user may elect to sort or rank the content based on trends in the social media. For example, a user may wish to know what information is currently trending on one or more social media servers or services such as one or more of Twitter, Facebook, Digg or Google Buzz. While a limited number and type of social media services are described for purposes of illustration, it should be understood that any suitable social media service could be used and still fall within the described embodiments.

In various embodiments, trending component 120 may be operative to determine a social metric score for each of a plurality of content using social media trending information received from one or more social media servers or services and to rank the content based on the social metric score. For example, trending component 120 may receive a request to sort content based on social media trending information. The request may originate from any number of locations, including client system 110 such as a user request. In response to receiving the sorting request, trending component 120 may select a plurality of content contained on one or more web servers. For example, trending component 120 may select a predetermined number of most recently created content to ensure that any ranking or sorting includes recent or relevant information.

Trending component 120 may send a request to one or more social media servers 140-1-n to obtain social media trending information for the plurality of content in some embodiments. In various embodiments, the social media trending information may comprise an aggregate number of links, comments, shares or other social media identifiers associated with the content. In some embodiments, for example, the request may be sent to the one or more social media servers using one or more third party application programming interfaces (APIs) to communicate with the one or more social media servers. For example, each social media service may include one or more APIs operative to allow third party services to access information from the social media service. These APIs may include any suitable interface and in some embodiments may comprise open source code.

The social media trending information may be received from the one or more social media services 140-1-n in some embodiments. In various embodiments, the social media trending information may be used by trending component 120 to calculate a social metric score for each of the plurality of content. For example, calculating a social media metric may comprise dividing the social media trending information by a timing factor and multiplying the quotient by a fixed number. An example social metric score formula is illustrated below for purposes of illustration and not limitation:

AggregateHits=(Diggs+FacebookShares+FacebookLikes+FacebookComments+Tweets);

Divisor=((StartDateInSeconds)/60)/60;

Social Metric Score=(AggregateHits/Divisor)×500,000

In various embodiments, Diggs may comprise a number of votes or ‘diggs’ from social media service Digg, FacebookShares may comprise a number of times a link associated with content has been shared using the social media service Facebook, FacebookLikes may comprise a number of likes or votes received on the social media service Facebook and Tweets may comprise a number of posts on the social media service Twitter. The foregoing formulas and variables may be used, as an example, to calculate a social metric score. A person skilled in the art would understand that any number or type of social metric information could be used to calculate the AggregateHits, that the Divisor could be based on any suitable StartDate and that the multiplier in the Social Metric Score formula (e.g. 500,000) comprises an arbitrary number selected for purposes of illustration. Other embodiments are described and claimed.

Trending component 120 may be operative to rank the content based on the social metric score in some embodiments. For example, content may be ordered or ranked according to the scores obtained using the above or a similar social metric score formula. In various embodiments, the content may be presented on one or more websites in an order determined based on the social metric score and the calculated ranking for the content. For example, CNET.com may include a number of articles, review or other content that may be ranked on the website based on a social metric score for each piece of content.

In various embodiments, the selecting, requesting, calculating and ranking performed by the trending component 120 may be periodically repeated. For example, periodically repeating the operations of the trending component 120 may help to ensure that current trending information is included when ranking content. In some embodiments, the periodic repeating occurs at a rate determined based on a rate limit received from one or more of the social media web servers. For example, each social media service may include a different rate limit, often defined in terms of requests per hour (rph), that may define how may times a request can be made to the social media service. In some embodiments, trending component 120 may maintain a separate rate limit for each social media service. In other embodiments, trending component 120 may select a rate limit corresponding to a lowest rate limit allowed by a social media service included in the social metric formula. In various embodiments, the rate limits may be negotiable and may be increased as necessary to provide accurate trending information. Other embodiments are described and claimed.

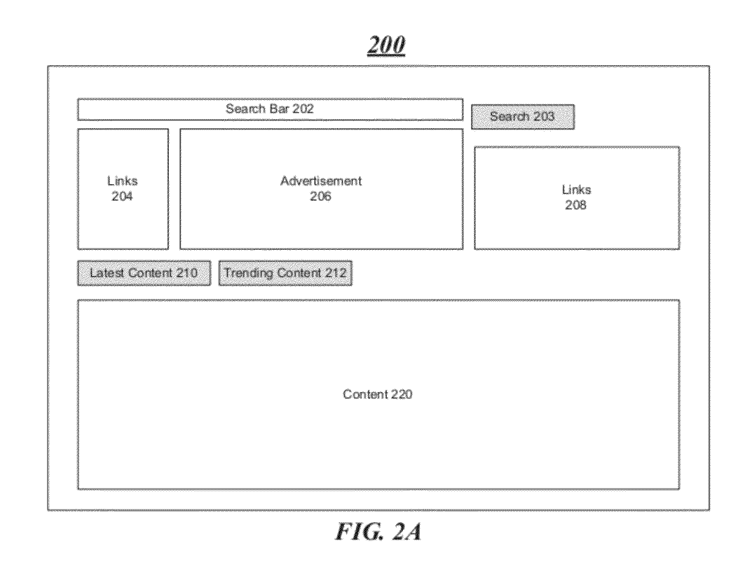

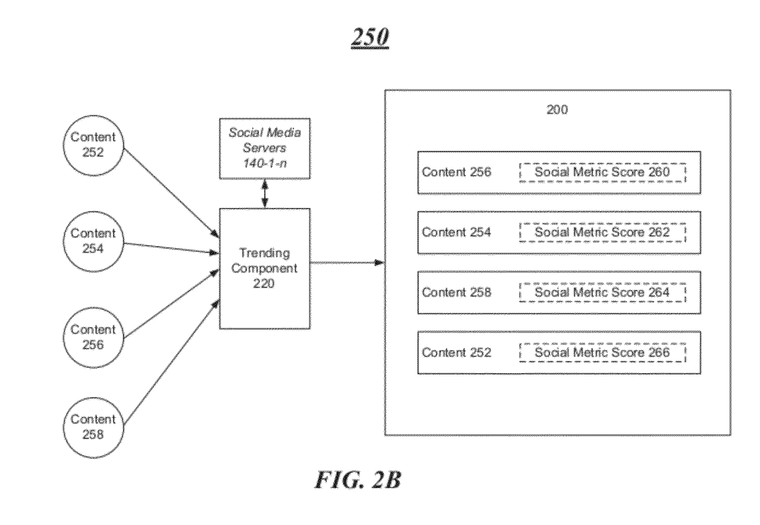

FIG. 2A illustrates one embodiment of a user interface 200. In various embodiments, user interface 200 may comprise a visual representation of a website that is accessible by users of client system 100 of FIG. 1, for example. In various embodiments, the website may comprise CNET.com, although the embodiments are not limited in this respect. As shown in FIG. 2A, user interface 200 may include any number or arrangement of data, information, buttons, fields, toggles, radio buttons, links or any other information or interactive entity suitable for use on a dynamic website.

In various embodiments, the user interface 200 may include a search bar 202. Search bar 202 may be operative to allow users to search website 200 for any type of content using any number or type of search algorithms. Search button 203 may include a button to activate a search using any identifying information entered in search bar 202. User interface 200 may include links 204 and 208 in some embodiments. Links 204 and 208 may comprise any suitable hyperlink that points to or directs a user to another document, element or website. User interface 200 may also include advertisement 206 in some embodiments. Advertisement 206 may include a link to or identifier for a third party product or service. The embodiments are not limited in this respect.

User interface 200 may include a latest content button 210. By pressing the latest content button 210, a user may receive a list of the latest content that has been published for the website 200. The content may be displayed in any suitable fashion as shown in content 220. User interface 200 may also include trending content button 212. By pressing the trending content button 212, a user may receive a ranked or sorted list of content that is trending in the social media that may be presented as content 220. For example, a user may press trending content button 212, which may activate a trending component or algorithm on a web server, which may perform operations similar to those described above with respect to trending component 120 of FIG. 1. While a limited number, type and arrangement of information and elements are shown in FIG. 2 for purposes of illustration, it should be understood that any suitable number, type or arrangement could be used and still fall within the described embodiments.

FIG. 2B illustrates one embodiment of a logic flow 250. As shown in FIG. 2B, logic flow 250 includes content 252, 254, 256 and 258, trending component 220, social media servers 140-1-n, user interface or website 200 and social metric scores 260, 262, 264 and 266. The embodiments are not limited to the number, type or arrangement of elements shown in FIG. 2B. In various embodiments, trending component 220 and social media servers 140-1-n may be the same or similar to trending component 120 and social media servers 140-1-n of FIG. 1 respectively. Similarly, user interface or website 200 may be the same or similar to user interface 200 of FIG. 2A. The embodiments are not limited in this context.

In various embodiments, logic flow 250 may be representative of the operations performed by trending component 120 or 220 to select, rank and sort content based on social media metrics. In some embodiments, trending component 220 may select or receive content 252, 254, 256 and 258. The content 252, 254, 256 and 258 may be received or selected, for example, from memory 104-2 of server system 130. After receiving the content, trending component 220 may request and receive social media trending information for each piece of content 252, 254, 256 and 258 from social media servers 140-1-n. Trending component 220 may be operative to calculate a social metric score 260, 262, 264 and 268 for each piece of content 252, 254, 256 and 258 and may further be operative to rank the content 252, 254, 256 and 258 based on the calculated social metric scores 260, 262, 264 and 268.

Trending component 220 may be operative to output the ranked or sorted content 252, 254, 256 and 258 based on the respective social metric scores 260, 262, 264 and 268 to one or more websites 200 in some embodiments. For example, content 256 may have received the highest social metric score 260 and therefore may be presented at the top of the list of content on website 200. Lower social metric scores may have been received by content 254, 258 and 252 and these pieces of content may therefore be ranked based on their respective social metric scores 262, 264 and 266 below content 256 on website 200. The embodiments are not limited in this context.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

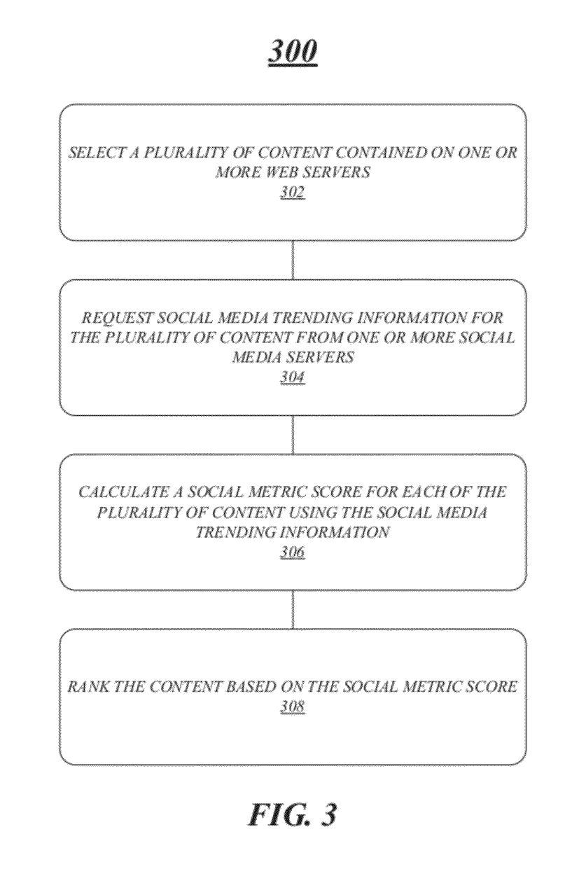

FIG. 3 illustrates one embodiment of a logic flow 300. The logic flow 300 may be representative of some or all of the operations executed by one or more embodiments described herein. In the illustrated embodiment shown in FIG. 3, the logic flow 300 includes selecting a plurality of content contained on one or more web servers at 302. For example, trending component 120 of FIG. 1 may be operative to select a plurality of most recently published articles, news or user reviews from server system 130 in response to a request from a user for content at client system 110.

The logic flow 300 may include requesting social media trending information for the plurality of content from one or more social media servers at 304. For example, trending component 120 of FIG. 1 may be operative to request social media trending information from one or more of social media servers 140-1-n. In some embodiments, requesting the social media trending information may be done using one or more third party application programming interfaces (APIs) to communicate with the one or more social media servers 140-1-n. In various embodiments, the one or more social media servers comprise one or more social media services provided by one or more of Twitter, Facebook, Digg or Google Buzz and the social media trending information may comprise an aggregate number of links, comments, shares or other social media identifiers associated with the content as discussed above with respect to FIG. 1. In some embodiments, the social media trending information may comprise information or referrals from web based email clients, such as Hotmail® or Gmail®, for example. The information referrals may comprise, in various embodiments, links to content contained within emails sent using the above-referenced services, or any other type of suitable referral or link.

In various embodiments, the logic flow 300 may comprise calculating a social metric score for each of the plurality of content using the social media trending information at 306. For example, trending component 120 may be operative to calculate a social metric score for each piece of content using the information obtained from the one or more social media servers 140-1-n. In some embodiments, calculating the social metric score for each of the plurality of content may comprise using a formula comprising dividing the social media trending information by a timing factor and multiplying the quotient by a fixed number, as discussed above with respect to the social metric formulas.

The logic flow 300 may include ranking the content based on the social metric score at 308 in some embodiments. For example, trending component 120 may be operative to use the social metric score to rank, sort or other establish an order for the content. The ranking or order may be used, in some embodiments, for presenting the content on one or more websites after receiving a request to sort content based on social media trending information. For example, a user of client system 110 of FIG. 1 may request content based on social media trending information. In response, trending component 120 may be operative to sort a number of most recent content based on the trending information, and present the content in a ranked order on a website accessible by the user of client system 110.

In various embodiments, selecting a plurality of content may comprise selecting a predetermined number of most recently created content. For example, the predetermined number of most recently created content may comprise the one hundred most recently created content in some embodiments. It should be understood that any number of most recently created content could be used and still fall within the described embodiments. In some embodiments, other factors may also be included when selecting content, such as past trending metric scores, relevance, hits, user preferences, content creator rankings or any other suitable factor. Other embodiments are described and claimed.

In some embodiments, the selecting, requesting, calculating and ranking of logic flow 300 may be periodically repeated. For example, the periodic repeating may occur at a rate determined based on a rate limit received from one or more of the social media web servers. In some embodiments, the periodic repeating may occur in twenty-minute intervals. The embodiments are not limited in this content.

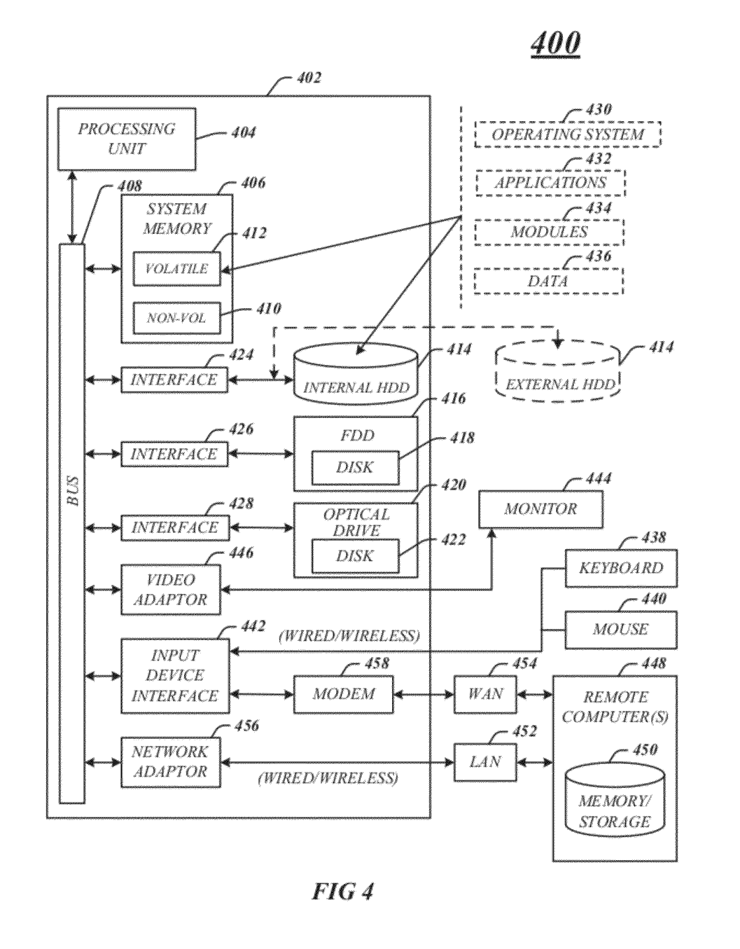

FIG. 4 illustrates an embodiment of an exemplary computing architecture 400 suitable for implementing various embodiments as previously described. The computing architecture 400 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 400.

As shown in FIG. 4, the computing architecture 400 comprises a processing unit 404, a system memory 406 and a system bus 408. The processing unit 404 can be any of various commercially available processors. Dual microprocessors and other multi-processor architectures may also be employed as the processing unit 404. The system bus 408 provides an interface for system components including, but not limited to, the system memory 406 to the processing unit 404. The system bus 408 can be any of several types of bus structure that may further interconnect to a memory bus (with or without a memory controller), a peripheral bus, and a local bus using any of a variety of commercially available bus architectures.

The system memory 406 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 4, the system memory 406 can include non-volatile memory 410 and/or volatile memory 412. A basic input/output system (BIOS) can be stored in the non-volatile memory 410.

The computer 402 may include various types of computer-readable storage media, including an internal hard disk drive (HDD) 414, a magnetic floppy disk drive (FDD) 416 to read from or write to a removable magnetic disk 418, and an optical disk drive 420 to read from or write to a removable optical disk 422 (e.g., a CD-ROM or DVD). The HDD 414, FDD 416 and optical disk drive 420 can be connected to the system bus 408 by a HDD interface 424, an FDD interface 426 and an optical drive interface 428, respectively. The HDD interface 424 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 410, 412, including an operating system 430, one or more application programs 432, other program modules 434, and program data 436. The one or more application programs 432, other program modules 434, and program data 436 can include, for example, the trending component 120 of FIG. 1.

A user can enter commands and information into the computer 402 through one or more wire/wireless input devices, for example, a keyboard 438 and a pointing device, such as a mouse 440. Other input devices may include a microphone, an infra-red (IR) remote control, a joystick, a game pad, a stylus pen, touch screen, or the like. These and other input devices are often connected to the processing unit 404 through an input device interface 442 that is coupled to the system bus 408, but can be connected by other interfaces such as a parallel port, IEEE 1394 serial port, a game port, a USB port, an IR interface, and so forth.

A monitor 444 or other type of display device is also connected to the system bus 408 via an interface, such as a video adaptor 446. In addition to the monitor 444, a computer typically includes other peripheral output devices, such as speakers, printers, and so forth.

The computer 402 may operate in a networked environment using logical connections via wire and/or wireless communications to one or more remote computers, such as a remote computer 448. The remote computer 448 can be a workstation, a server computer, a router, a personal computer, portable computer, microprocessor-based entertainment appliance, a peer device or other common network node, and typically includes many or all of the elements described relative to the computer 402, although, for purposes of brevity, only a memory/storage device 450 is illustrated. The logical connections depicted include wire/wireless connectivity to a local area network (LAN) 452 and/or larger networks, for example, a wide area network (WAN) 454. Such LAN and WAN networking environments are commonplace in offices and companies, and facilitate enterprise-wide computer networks, such as intranets, all of which may connect to a global communications network, for example, the Internet.

When used in a LAN networking environment, the computer 402 is connected to the LAN 452 through a wire and/or wireless communication network interface or adaptor 456. The adaptor 456 can facilitate wire and/or wireless communications to the LAN 452, which may also include a wireless access point disposed thereon for communicating with the wireless functionality of the adaptor 456.

When used in a WAN networking environment, the computer 402 can include a modem 458, or is connected to a communications server on the WAN 454, or has other means for establishing communications over the WAN 454, such as by way of the Internet. The modem 458, which can be internal or external and a wire and/or wireless device, connects to the system bus 408 via the input device interface 442. In a networked environment, program modules depicted relative to the computer 402, or portions thereof, can be stored in the remote memory/storage device 450. It will be appreciated that the network connections shown are exemplary and other means of establishing a communications link between the computers can be used.

The computer 402 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

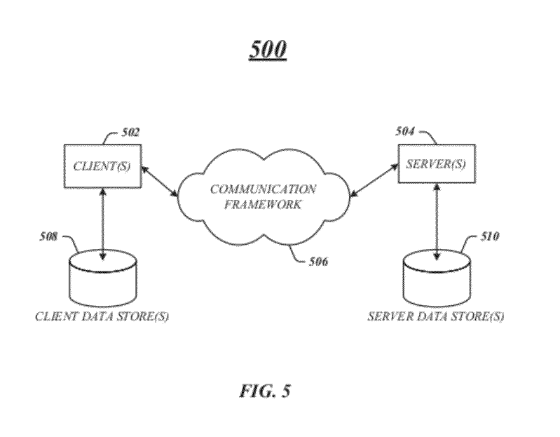

FIG. 5 illustrates a block diagram of an exemplary communications architecture 500 suitable for implementing various embodiments as previously described. The communications architecture 500 includes various common communications elements, such as a transmitter, receiver, transceiver, radio, network interface, baseband processor, antenna, amplifiers, filters, and so forth. The embodiments, however, are not limited to implementation by the communications architecture 500.

As shown in FIG. 5, the communications architecture 500 comprises one or more clients 502 and servers 504. The clients 502 may implement the client systems 110. The servers 504 may implement the server system 330 and 340-1-n. The clients 502 and the servers 504 are operatively connected to one or more respective client data stores 508 and server data stores 510 that can be employed to store information local to the respective clients 502 and servers 504, such as cookies and/or associated contextual information.

The clients 502 and the servers 504 may communicate information between each other using a communication framework 506. The communications framework 506 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 502 and the servers 504 may include various types of standard communication elements designed to be interoperable with the communications framework 506, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 502 and a server 504 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. In various embodiments, the storage medium may include a non-transitory storage medium. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
selecting a plurality of content contained on one or more web servers;
requesting social media trending information for the plurality of content from one or more social media servers;
calculating a social metric score for each of the plurality of content using the social media trending information; and
ranking the content based on the social metric score.

2. The computer-implemented method of claim 1, comprising receiving a request to sort content based on social media trending information; and
presenting the content on one or more websites in an order determined based on the social metric score.

3. The computer-implemented method of claim 1, comprising:
requesting the social media trending information using one or more third party application programming interfaces (APIs) to communicate with the one or more social media servers.

4. The computer-implemented method of claim 1, wherein the one or more social media servers are operative to implement one or more social media websites.

5. The computer-implemented method of claim 1, wherein the social media trending information comprises an aggregate number of links, comments, shares or other social media identifiers associated with the content on one or more of the social media servers.

6. The computer-implemented method of claim 5, comprising:
calculating the social metric score for each of the plurality of content using a formula comprising dividing the social media trending information by a timing factor and multiplying the quotient by a fixed number.

7. The computer-implemented method of claim 1, wherein selecting a plurality of content comprises selecting a predetermined number of most recently created content.

8. The computer-implemented method of claim 7, wherein the predetermined number of most recently created content comprises the one hundred most recently created content.

9. The computer-implemented method of claim 1, comprising:
periodically repeating the selecting, requesting, calculating and ranking.

10. The computer-implemented method of claim 9, wherein the periodic repeating occurs at a rate determined based on a rate limit received from one or more of the social media web servers.

11. An article comprising a store medium containing instructions that when executed by a processor enable a system to:
receive a request to sort content based on social media trending information;
select a plurality of content contained on one or more web servers;
send a request to one or more social media servers to obtain social media trending information for the plurality of content;
receive the social media trending information;
calculate a social metric score for each of the plurality of content using the social media trending information;
rank the content based on the social metric score; and
present the content on one or more websites in an order determined based on the social metric score.

12. The article of claim 11, further comprising instructions that when executed enable the system to:
request the social media trending information using one or more third party application programming interfaces (APIs) to communicate with the one or more social media servers, wherein the one or more social media servers are operative to implement one or more social media websites.

13. The article of claim 11, wherein the social media trending information comprises an aggregate number of links, comments, shares or other social media identifiers associated with the content on one or more of the social media servers.

14. The article of claim 11, further comprising instructions that if executed enable the system to:
divide the social media trending information by a timing factor and multiply the quotient by a fixed number to calculate the social metric score for each of the plurality of content.

15. The article of claim 11, further comprising instructions that if executed enable the system to:
select a predetermined number of most recently created content, wherein the predetermined number of most recently created content comprises the one hundred most recently created content.

16. The article of claim 11, further comprising instructions that if executed enable the system to:
periodically repeat the selecting, requesting, calculating and ranking.

17. The article of claim 16, further comprising instructions that if executed enable the system to:
periodically repeat the selecting, requesting, calculating and ranking at a rate determined based on a rate limit received from one or more of the social media web servers.

18. An apparatus, comprising:
one or more processors;
a memory communicatively coupled to the one or more processors; and
a trending component stored in the memory that when executed by the processor is operative to determine a social metric score for each of a plurality of content using social media trending information received from one or more social media servers and to rank the content based on the social metric score.

19. The apparatus of claim 18, the trending component operative to:
receive a request to sort content based on social media trending information;
select a plurality of content contained on one or more web servers;
send a request to the one or more social media servers to obtain the social media trending information for the plurality of content;
receive the social media trending information;
calculate a social metric score for each of the plurality of content using the social media trending information; and
rank the content based on the social metric score.

20. The apparatus of claim 19, the trending component operative to:
present the content on one or more websites in an order determined based on the social metric score.

21. The apparatus of claim 19, wherein the social media trending information comprises an aggregate number of links, comments, shares or other social media identifiers associated with the content on one or more of the social media servers and wherein the calculating comprises dividing the social media trending information by a timing factor and multiplying the quotient by a fixed number.

22. The apparatus of claim 19, wherein selecting a plurality of content comprises selecting a predetermined number of most recently created content.

23. The apparatus of claim 19, the trending component operative to:
periodically repeat the selecting, requesting, calculating and ranking, wherein the periodic repeating occurs at a rate determined based on a rate limit received from one or more of the social media web servers.

24. The apparatus of claim 19, the trending component operative to:
request the social media trending information using one or more third party application programming interfaces (APIs) to communicate with the one or more social media servers, wherein the one or more social media servers are operative to implement one or more social media websites.
